(19) United States
(12) Patent Application Publication
(10) Pub. No.: US 2002/0152301 A1
(43) Pub. Date: Oct. 17, 2002

(54) System and method for determining the state of a service within a computer network

(75) Inventors: Jack K. Garrett, Dallas, TX (US); Jack D. Dingler JR., Irving, TX (US)

Correspondence Address: Michael L. Daiz, Michael L. Daiz, P.C., Suite 200, 555 Republic Drive, Plano, TX, 75074, US

(73) Assignee: Reactive Networking, Inc.

(21) Appl. No.: 09/740,471

(22) Filed: Dec. 19, 2000

(51) Int. Cl. G06F 15/173

(52) U.S. Cl. 709/224

(57) ABSTRACT

A method and system for determining the state of a service within a computer network. The system includes at least one computer platform connected with the computer network. The computer platform provides a service. A load is defined by load metrics for the computer platform. The system also includes the capability for obtaining the metrics from the computer platform and a load reporter for calculating from the metrics a total load associated for the service. The load reporter also creates a report of the total load associated for the service. The system may also include a second computer platform having metrics, which are calculated into the total load of the service. The system may also automatically scale a second load associated with the second computer platform by comparing the second computer platform's performance characteristics with the first computer platform's performance characteristics.

### BACKGROUND OF THE INVENTION

1. Technical Field of the Invention

This invention relates to network server computers and, more particularly, to a system and method for determining the state of a service within a computer network.

2. Description of Related Art

With the proliferation of client/server computers, operators have found a corresponding demand for the availability and quality of services associated with their businesses. In the past, a service was merely associated and identified with a local server providing a specified service. However, with recent advances in client/server computing, services can no longer be associated with a single server. For example, hyper-text transfer protocol (HTTP) servers associated in providing services to Internet users frequently depend on database servers to provide desired information to an HTTP client. The client has no direct connection with the database server, however, the HTTP server is the client of the database server. The database server is known as an upstream resource to the HTTP server. Although the client may only know of one service, such as a web page, that service may actually involve multiple physical entities or services. Thus, the presentation displayed to the client may be an abstraction of a compilation of various services and their associated physical entities.

Additionally, the demand for a particular service may require the utilization of more than one physical entity. Although several physical entities may be utilized, a client may only know one logical entity associated with a particular service. The client associates the presentation point as the logical entity providing services to the client. For example, the client is presented data at a particular presentation point (e.g., xyz.com). However, xyz may actually utilize fifty HTTP servers. By utilizing multiple physical entities, computer personnel encounter various problems associated with determining the state of a service when it is spread across a plurality of physical and logical resources.

These problems are further compounded by the complexity and multitude of different types of computer hardware and software. A particular service utilizing one operating system may have different performance characteristics than the service utilizing a different operating system. In addition, different services may depend on different resources associated with a computer platform. For example, some services may require high amounts of disk I/O, while other services may require mostly floating point math. Still other services may require heavy use of an upstream resource, such as a database server, and are dependent on the network resources available to the host server.

Advancements in technology have rapidly increased the performance characteristics of various computer platforms. Thus, a particular make and model of a host server purchased today will most likely have different performance characteristics as compared to host server being of the same make and model purchased six months ago. In addition, with the fluctuation in prices of computing platforms, a company may purchase a wide variety of servers. Since various types of servers may be utilized by a company, a wide range of response time and capability may be seen by the various servers. The client utilizing the company's service may experience varying response times, depending on which particular server is serving the client.

Many of the problems associated with the management and load distribution of computer platforms have been addressed in one form or another with traffic control and other load balancing techniques. However, many of these techniques utilize an approach of considering everything as equal in terms of computer platforms and the services they provide. Some of these solutions include utilizing the network computing platforms on a round robin or a random distribution scheme. However, as discussed above, the solutions assume that all connections impact an equal load on the server and that all the servers are equal in scale and performance.

There are several drawbacks associated with assuming all connections are equal. The various ranges of capabilities offered by a service and the ability of the client to control which capabilities being used are not considered. One client may be browsing a few static HTML pages, while another client may perform complex database queries through dynamic Web pages. Obviously, the client performing the database queries is imparting a different load on the server than the user browsing static web pages.

Still, other solutions to the above-mentioned problems include determining the load of a server using implied metrics. Metrics define various performance characteristics of the server. Implied metrics involve assuming that the amount of network traffic the server is receiving defines the load on the server. However, the assumption that the load of a server must be associated merely with the amount of network traffic the server sends and receives does not take into account the computations and manipulation of the data that is being sent and received. For example, one simple HTTP request for an index search could generate very little traffic. A few bytes for the request and the response may be sent across the network. However, that one request, may have caused a very heavy load on the server due to the size of the index which may have been searched. Another client may browse a relatively large and complex static web page or pages, which may generate a heavy network load. The load on the server performing this type of operation may be low due to the pages being cached in memory and very few computing resources being required. The assumption that the traffic load determines the load of a server may lead to an erroneous determination of the load of a particular server.

It has been clearly seen that the metrics of the endpoint server must be considered in the determination of a load on the server. Another metric used in existing systems in determining the load of a server may include CPU utilization or NIC adapter utilization. However, merely using one of these metrics provides incorrect load determination of the service on the server. For example, if CPU utilization is used as the metric to determine the load on a server, it would imply that a high CPU utilization is a high load. Generally, the assumption is that if the CPU is busy, there is a high response time and if the CPU is not busy, then there is a low response time associated with that server. However, CPU utilization is a linear metric. There may be little effect on response times with CPU utilization of up to forty or fifty percent. After this threshold is reached, there may be a noticeable ramping effect where response times become disproportionally longer in relationship to CPU utilization. Additionally, with the advent of an intelligent subsystem (e.g., SCSII/O, discrete floating point hardware, etc.) and the dependency on upstream resources, the server's CPU is freed from many of the tasks that affect response times. A service waiting for responses from a database server will go into a wait state until the data is returned from the database server and the application can continue processing. A server that is experiencing a large number of upstream service requests may have a lower CPU utilization due to a large queue of unsatisfied database request, which may result in the longest response times. Additionally, existing method and systems do not make any adjustment for differing platforms and their performance characteristics. Although there are no known prior art teachings of a solution to the aforementioned deficiency and shortcoming such as that disclosed herein, prior art references that discuss subject matter that bears some relation to matters discussed herein are U.S. Pat. No. 5,053,950 to Naganuma et al. (Naganuma), U.S. Pat. No. 5,774,668 to Choquier et al. (Choquier), U.S. Pat. No. 5,867,706 to Martin et al. (Martin), U.S. Pat. No. 5,933,606 to Mayhew (Mayhew), and U.S. Pat. No. 6,070,191 to Narendran et al. (Narendran).

Naganuma discloses a multi-processor system having a plurality of processors and a network system linking the processors to process a given computational load written in a logic programming language. According to an initial load balancing algorithm, each processor independently and dynamically selects an initial load segment from the given load by use of system information representative of characteristics of the multi-processor system without transferring information between the processors, whereby an initial load balancing is obtained in the multi-processor system. According to a load balancing algorithm for reproducing working environments, an algorithm is performed after performing the initial load balancing algorithm and a partial load segment of a first processor is shared with a second processor. However, Naganuma does not teach or suggest monitoring a plurality of performance characteristics of a server or processor. Additionally, Naganuma does not disclose associating any performance characteristics of the processor with a selectable scale to define the load on the processor.

Choquier discloses an on-line service network which includes application servers and gateway microcomputers that are interconnect by a LAN. The microcomputers receive service requests which are transmitted from client microcomputers operated by end users. Upon receiving a request to open service, the microcomputers access a periodically-updated service map to locate the replicated application servers that are currently running the corresponding service application, and then apply a load balancing method to select an application server that has a relatively low processing load. Choquier does not disclose monitoring a plurality of performance characteristics of a server. Choquier merely discloses monitoring the CPU utilization for the server. Additionally, Choquier does not teach or suggest including upstream resources in calculating a load on the servers.

Martin discloses a server computer connected to a network and having a plurality of processors arranged to provide a service to one or more client computers connected to the network. Martin also discloses a load determining means which periodically determines activity data for the processor for inclusion in a load distribution record maintained for all of the processors of the server. It is then determined which processor should service a request from the client computer for that subsequent block of information and includes an address for that processor in the file constructed by the block retrieval means. Although Martin discloses a load determining means for determining the load of each processor, Martin does not teach or suggest monitoring a plurality of performance characteristics of the server. Martin merely discloses determining if each processor is “busy.” Martin also does not teach or suggest including any upstream resources in the determination of the load of the processor.

Mayhew discloses the use of hyper-text transfer protocol (HTTP) links which are contained within web pages to facilitate load balancing across multiple servers containing the same information. The links in the web pages are used to load balance, eliminating the need for special hardware or special organization of the existing hardware. However, Mayhew does not teach or suggest monitoring a plurality of performance characteristics or associating the characteristics with a selectable scale for defining the load of a server. Mayhew merely discloses monitoring and reporting when a server is busy.

Narendran discloses a server system for processing client requests received over a communication network. The system includes a cluster of document servers and at least one redirection server. The redirection server receives a client request from the network and redirects it to one of the document servers, based on a set of pre-computed redirection probabilities. Each document server may be an HTTP server that manages a set of documents locally and can service client requests only for the locally-available documents. A set of documents are distributed across the document servers in accordance with a load distribution algorithm which may utilize the access rates of the documents as a metric for distributing the documents across the servers and determining the redirection probabilities. But Narendran does not teach or suggest monitoring a plurality of performance characteristics or utilizing a scale to define the load on the server. Narendran merely discloses distributing the load on a plurality of servers based on each server's capacity in terms of maximum number of HTTP connections that the server can support simultaneously.

None of the existing systems of methods incorporate the loads of upstream resources in traffic control or load distribution determination at the service presentation point. Additionally, no existing system or method determines the load of a service based on the multiple load and resource utilization metrics that are specific to a particular service. There is also no system or method which can automatically adjust the load calculation and resource utilization curve when calculating a plurality of server loads.

Thus, it would be a distinct advantage to have a system and method which accurately determine the service state of a server utilizing load information from upstream resources as well as specific metrics associated with the server's service. Additionally it would be advantageous to have a system and method of monitoring a plurality of performance characteristics and associate the performance characteristics with a selectable scale. It is an object of the present invention to provide such a system and method.

### SUMMARY OF THE INVENTION

In one aspect, the present invention is a system for determining the state of a service for a specified computer platform. The computer platform may be standalone or connected with a plurality of computer platforms within a computer network. The system includes a plurality of computer platforms connected within the computer network. Each computer platform has load metrics defining a load on each computer platform. The plurality of computer platforms are utilized by a service within the computer network. The system also obtains the load metrics from the plurality of computer platforms. Additionally, the system also includes a load reporter for calculating from the load metrics a total load associated for the service. The load reporter provides a report of the state of the service within the computer network.

In another aspect, the present invention is a system for determining the state of a service within a computer network. The system includes

a first computer platform connected with the computer network. The first computer platform has load metrics defining a first load on the first computer platform. Additionally, the first computer platform provides a service within the computer network. The system also includes the capability for obtaining the load metrics from the first computer platform and a load reporter for calculating from the load metrics a total load associated for the service. The load reporter provides a report of the total load associated for the service. The system may also include a second computer platform having load metrics defining a second load on the second computer platform. The system automatically scales the second load associated with the second computer platform by comparing the second computer platform's performance characteristics with the first computer platform's performance characteristics.

In still another aspect, the present invention is a method of determining the state of a service in a computer network. The method begins by determining relevant metrics defining a first load of a first computer platform. The first computer platform provides a service. Next, a load reporter receives the relevant metrics. The load reporter than calculates a total load of the service.

In another aspect, the present invention is a method of determining a load of a service within a computer network. The method begins by determining relevant metrics defining a first load of a first computer platform. The first computer platform has a first set of performance characteristics and provides a service. Next, a load reporter receives the relevant metrics of the first computer platform. The method moves on by determining relevant metrics defining a second load of a second computer platform. The second computer platform also includes a second set of performance characteristics and is a resource utilized by the first computer platform. Next, the load of the second computer is automatically scaled. The load reporter than calculates a total load of the service by calculating the first load and proportionally adding the second scaled load to determine the total load of the service.

In another aspect, the present invention is a method of determining a state of a service within a computer network having a first computer platform and a second computer platform providing a service. The method begins by determining relevant metrics to define a first load on the first computer platform and a second load on the second computer platform. The relevant metrics of the first and second computer platforms are retrieved by the load reporter. Next, a total load for the service is calculated by proportionally adding the first load and the second load to determine the total load.

### BRIEF DESCRIPTION OF THE DRAWINGS

The invention will be better understood and its numerous objects and advantages will become more apparent to those skilled in the art by reference to the following drawings, in conjunction with the accompanying specification, in which:

FIG. 1 is a simplified block diagram illustrating the components of a computer system in the preferred embodiment of the present invention;

FIG. 2 is a figure illustrating a load utilization curve of a server;

FIG. 3 is a flow chart outlining the steps for determining the state of a service in the computer system according to the teachings of the present invention;

FIG. 4 is a flow chart outlining the steps for automatically scaling a server during initial setup in the computer system according to the teachings of the present invention;

FIG. 5 is a simplified block diagram illustrating the components of a computer system in an alternate embodiment of the present invention; and

FIG. 6 is a simplified block diagram illustrating the components of a standalone computer platform in an alternate embodiment of the present invention.

### DETAILED DESCRIPTION OF EMBODIMENTS

The present invention is a system and method for determining the state of a service within a computer network.

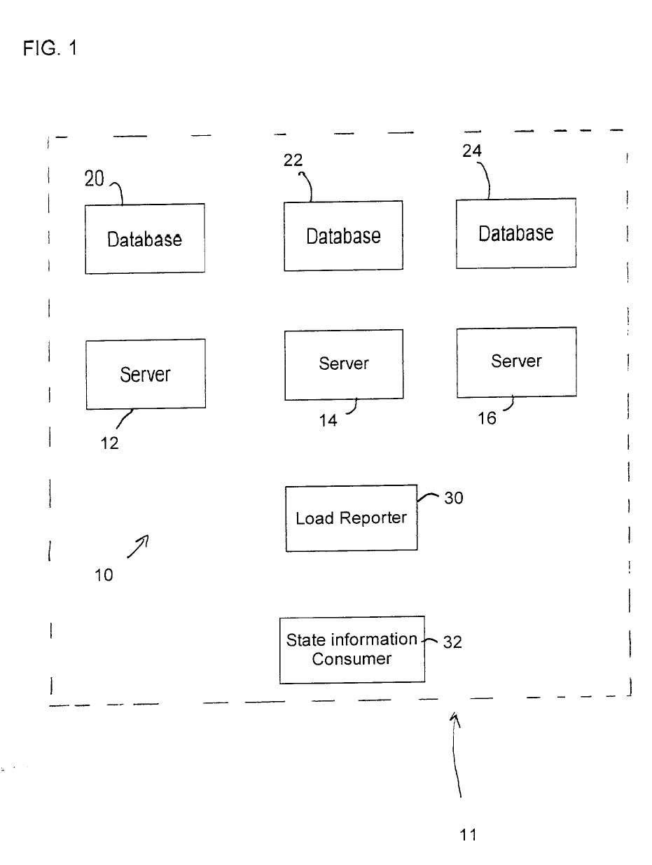

FIG. 1 is a simplified block diagram illustrating the components of a computer system 10 in the preferred embodiment of the present invention. The system includes a plurality of servers 12, 14, and 16 operating within a computer network 11. The servers 12, 14, and 16 utilize upstream resources, such as databases 20 and 22 and server 24. The system also includes a load reporter 30 who reports the service state of each service provided by the servers 12, 14, and 16 to a state information consumer 32, such as a load balancing agent.

The servers 12, 14, and 16 may be any computer platform connected within a computer network, such as an HTTP server, FTP server, etc. The servers 12, 14, and 16 may be connected to databases 20 and 22, as well as another upstream server 24. Each server may provide one or more services to a client utilizing the servers. The number and type of servers and databases may vary depending on the system 10's requirements and capabilities.

The load reporter 30 gathers specific performance data from each server for which it is concerned (servers 12, 14, and 16). The performance data is commonly referred to as metrics. Some metrics which may provide an indication of the true load of the service may include connections per second, disk IO pending, CGI requests pending/in progress, NIC utilization, and load of an upstream resource (e.g., databases 20 and 22 and server 24). Additionally, other metrics, although not directly related to loads, may be monitored. For example, virtual memory, fixed memory pool, disk space, etc., are performance resources which requires action prior to the exhaustion of these resources. Exhaustion of these resources may result in a computer platform “crashing.” Thus, it may be critical to prevent the exhaustion of these resources. The specific metrics to be monitored is dependent on the service being provided. The monitored metrics are those metrics necessary to indicate an accurate load of a service.

The load reporter 30 interprets the monitored metrics and provides a determination of the service state or load on the referenced service. This determination of the load on the service may be presented in a variety of ways. For example, a numeric scale may be utilized indicating the load utilization of the specified service (e.g., one being idle and 10 being full utilization). In other embodiments, a coding scheme may be implemented to indicate a general load condition. In other embodiments, a percentile scale may be used.

The load reporter 30 provides the determination of each specified service to the state information consumer 32. The state information consumer is typically a system providing traffic control or load control over a plurality of servers. However, in alternate embodiments, the load reporter's determination may be sent anywhere necessary, such as a network administrator or another system requiring the service state information.

The load or state of the service, rather than a particular computer platform, is important. The load on a computer platform (e.g., server 12) may not be indicative of the actual load of the service for which it provides. Specifically, the server 12 may be utilizing upstream resources such as the server 24 or the databases 20 and 22. Thus, to provide an accurate indication of the load of the specified service, the metrics on the upstream resources may be required for determining the service state.

Still referring to FIG. 1, the operation of the computer system 10 will now be explained. First, during the initial setup of the system 10, services are grouped together into what is referred as logical services. Different services may require different resources. Thus, although the host server (e.g., servers 12, 14, or 16) provides a service, the host server may require the upstream resources of databases 20 and 22, or server 24 to implement the service. Thus, the services must be grouped logically to incorporate all the resources necessary to determine an accurate state of the service. Next, in order to determine the load of the service, specific metrics for all the resources utilized by a particular service must be selected. The selected metrics are used to create a load curve. The load curve provides an indication of each resource used by the specified service.

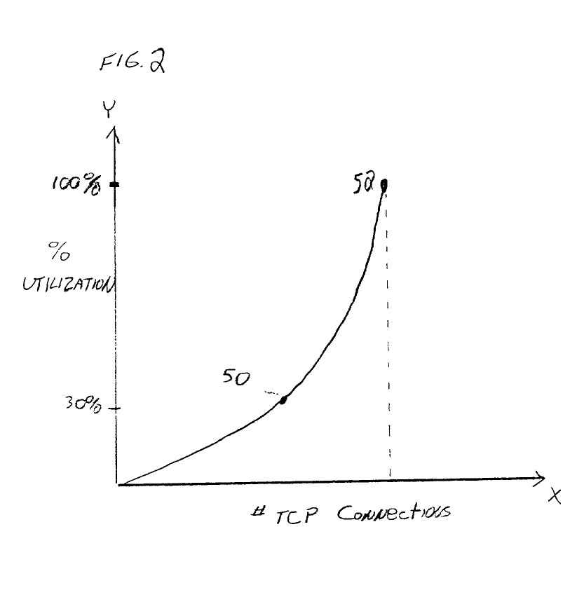

However, the load experienced by a server is not directly proportional to the amount of a resource that is being consumed. FIG. 2 is a figure illustrating a load utilization curve of a server. The X axis represents TCP connections while the Y axis represents the percentage of utilization. At the lower range of the number of TCP connections, the utilization percentage is relatively low. For example, at point 50, although half the total number of TCP connections that the server can connect are being utilized, only 30% of the resource is being utilized. However, as more TCP connections are utilized, the slope of the utilization percentage of the server increases dramatically. Eventually an upper limit, at point 52, is reached, where 100% of the resources are utilized.

As illustrated in FIG. 2, a linear curve may not be accurate. The unique “ramping” effect illustrated by the increased slope of FIG. 2 as more resources are utilized, must be calculated into the load curve calculations for the service. All the desired metrics for a host server and any associated upstream/downstream resources are used to create a custom load curve for a specified service. The load curve can be customized to proportionally account for the load of the upstream/downstream resource. Thus, a unique feature of the system 10 is the ability of an administrator of this system to set custom load curve calculations which accurately define the metrics for the specified service. Additionally, the system allows “chaining,” wherein upstream/downstream resources are calculated into the load curve.

While calculating the custom load curve for the specified service, an upper limit is established which is used as an end limit of the load curve. This upper limit sets the maximum load for the specified service, as associated with the host server.

The system 10 specifically monitors the metrics of all the resources necessary for determining the load curve of the service. Once the metrics are received from all resources, the load reporter 30 calculates the load for the service and creates a report. The report may include a percentage of utilization, a numeric scale, or a specific coding indicating a general load condition for the service. The load reporter can then report to a wide variety of entities, such as load balancing/traffic control appliances, monitors, or any tool which requires specific data on services operation within the system 10. In FIG. 1, the load reporter reports to the state information consumer 32 which balances the load of the plurality of resources within the system 10.

Another unique feature that the system 10 can perform is the gradual “weaning” of a server providing a service within the system 10. For example, if it is desired to remove server 14 from serving within the system 10, the load reporter may send an artificially high load for that server 14 to the state information consumer 32. Since clients are still using the server 14, rather than immediately taking the server off line, the state information consumer does not allow new clients to use the server 14. Eventually the current clients using the server 14 voluntarily disconnect from the server 14. Once all the clients are removed from the server 14, the server is removed from operation. In an alternate embodiment of the present invention, the load reporter can send a specialized code to the load reporting agent instructing the load reporting agent not to establish new clients on the server 14.

This process of weaning prevents current clients utilizing the server 14 from being disconnected. If the current clients are disconnected, there is a chance that they will not return to the system 10, but utilize a competitor's system.

Additionally, the system 10 can monitor disruptions to upstream resources which effect service for a particular server. If a specific server is unable to obtain upstream resources (e.g., unable to connect to a server or a database being inoperative), the load reporter can report that the server's load does not allow use within the system. Thus, any disruption to upstream resources can be minimized by utilizing other servers have fully functioning upstream resources.

With the proliferation of computing platforms, and more specifically servers, it is common for the system 10 to have a wide variety of servers in use. The plurality of servers may have vastly different performance characteristics. Rather than having to establish different policies or load calculations for every different type of server, which can be both time consuming and expensive, the system 10 provides for automatic scaling for each type of server. Automatic scaling involves adjusting the load calculation metrics to a different targeted server. Once the load calculation metrics are determined for a first server, these calculations are proportionately scaled to another server having different performance characteristics.

To achieve this automatic scaling, the system 10 defines performance scales for a base or initial server defining each calculated performance characteristic. These performance characteristics may include CPU bus memory, disk I/O, or any relevant performance characteristic of the server. When another different server is added to the system 10, the performance characteristics of the new server are appropriately scaled to automatically determine the load calculation curve for the new server.

For example, during initial setup, a specific policy establishing the calculated metrics and load curve for the specified service is created in reference to the server 12. Base performance characteristic are determined for the server 12. These performance characteristics may be obtained through a benchmark program or manually inputted by an operator. When it is desired to add the server 14 to the system 10, the relevant performance characteristics of the server 14 are obtained and compared to the base characteristic of the server 12. The load calculations for determining the load curve for the server 14 are automatically scaled in accordance with the server's performance characteristics. This automatic scaling feature of the system 10 allows consistent load calculations based on the server's capabilities. This prevents a more capable server from being underutilize while a less capable server is overburdened, thus enhancing the overall capability of the system 10.

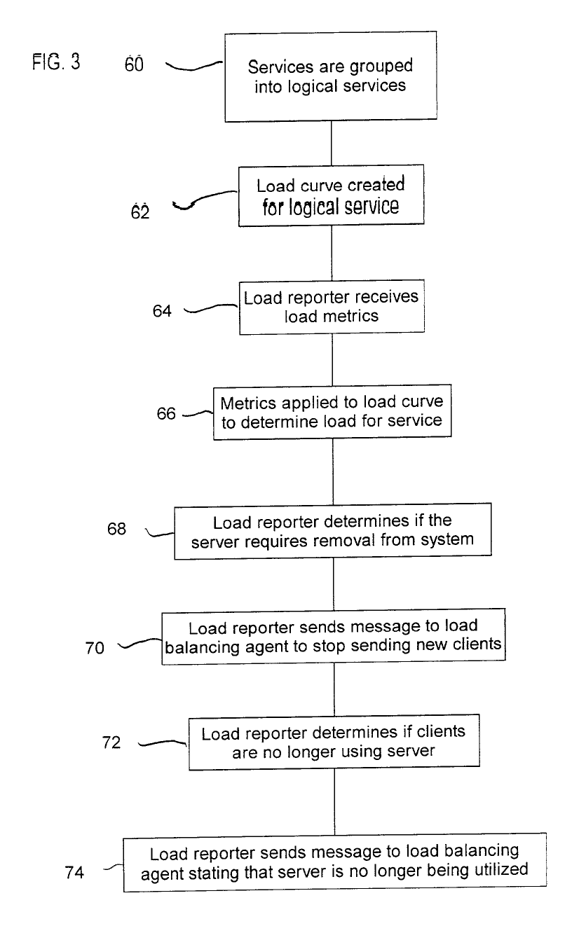

FIG. 3 is a flow chart outlining the steps for determining the state of a service in the computer system 10 according to the teachings of the present invention. With reference to FIGS. 1 and 3, the steps of the method will now be explained. The method begins with step 60 where services provided by the system 10 are grouped into logical services. Within each logical service, all the resources utilized in providing the specified service are determined, such as database servers, local host servers, and remote servers. Next, in step 62, a load curve associate with each logical service is created. The load curve is calculated by determining relevant metrics and their relative proportions for the various resources utilized by the service. Some of the metrics which are used in calculating the load curve include connections per second, disk IO pending, CGI requests pending/in progress, NIC utilization, and load of an upstream resource (e.g., databases 20 and 22 and server 24). Additionally, upper limits are established for the load curves. Some other metrics, although not directly related to loads, may be used in determining these upper limits. For example virtual memory, fixed memory pool, disk space, etc., may be used. If any of these resources are exhausted, the server may completely shut down. However, as long as these reference metrics are available, they are not a factor in calculating loads on a service. Thus, an upper limit on these resources is established.

As discussed above, the load metrics may include upstream resources which may be proportionally included within the calculations of the load curve utilized at a specified host server 12.

The method then moves on to step 64, where the relevant load metrics from all the resources are received by the load reporter 30, both local and remote (e.g., server 12, databases 20 and 22, and remote server 24), which are utilized by the specified service. The metrics may be received by any method allowing the transfer of performance data to the load reporter, such as a software application which monitor computer systems. These monitoring applications are well known in the art.

Next, in step 66, the metrics are applied to a specific point on the load curve and a load value is determined for the specified service. This load value is then converted to a value understandable by the entity receiving the load values. For example, a percent utilization for the service may be used. In alternate embodiments, a numeric scale, or code (e.g., green, yellow, and red) indicating the load condition for the specified service, may be used to convey the load condition of the service. The load reporter 30 then reports the load condition for the specified service, and the load conditions of specific resources utilized in the system. The report may then be sent to any entity requiring information on the load of the service.

Next, at step 68, the load reporter may optionally determine that a server 12 requires removal from operation in system 10, e.g., server requires service or replacement. The determination of whether the server 12 needs to be removed may be from external sources, such as the system 10 administrator, or obtained from receipt of the performance metrics of the server 12 to the load reporter. If the load reporter determines that the server 12 needs to be removed from service, the method moves to step 70 where the load reporter sends a message to the state information consumer 32 to stop sending new clients to the server 12. This message may take several different forms. First, the load reporter can send a special code specifically instructing the state information consumer to not connect new clients to the server 12. In another embodiment, the load reporter may send an artificially high load indication for server 12 to the state information consumer. In either embodiment, the state information consumer stops sending new clients to the server 12. However the server 12 remains in operation until the existing clients sign off the server 12.

Next, in step 72, it is determined by the load reporter if the remaining clients are no longer connected to the server 12. If the load reporter determines that no clients are using the server 12, the method moves to step 74, where the load reporter sends a message to the state information consumer that the server 12 is no longer being utilized. At this point, the server may be removed from service. By utilizing these steps to remove the server 12 from service, existing clients are not removed from existing connections with the system 10.

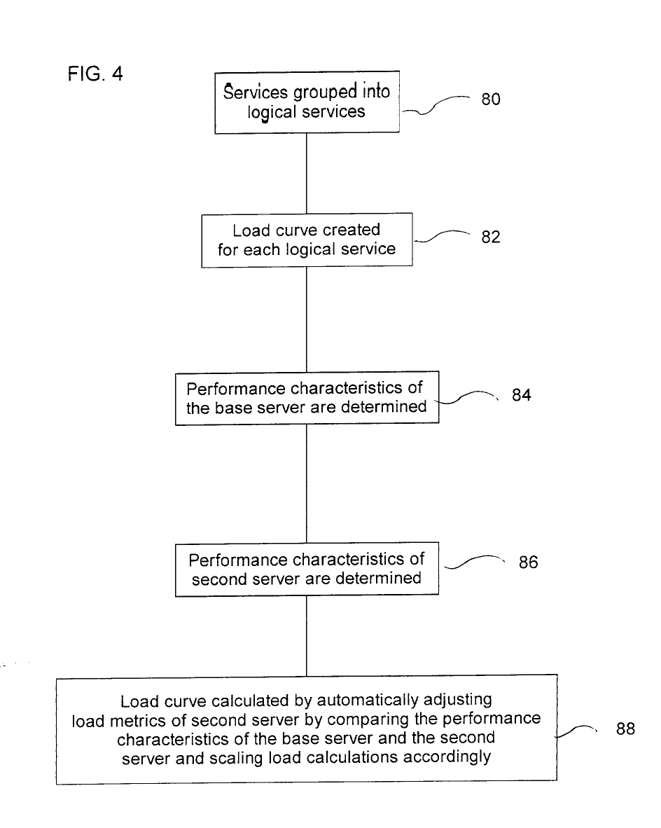

FIG. 4 is a flow chart outlining the steps for automatically scaling a server 14 during initial set up in the computer system 10 according to the teachings of the present invention. The method begins with step 80, where the services provided by the system 10 are grouped into logical services. The logical services are divided according to functionality and may include several computing platforms (e.g., upstream resources). Next, in step 82, a load curve associate with each logical service is created. As discussed in FIG. 3, the load curve is calculated by setting relevant metrics and proportions for the various resources utilized by the service. Some of the metrics which are used in calculating the load curve include connections per second, disk IO pending, CGI requests pending/in progress, NIC utilization, and a load or loads of an upstream resource (e.g., databases 20 and 22 and server 24). Additionally, upper limits are established for the load curves.

The method then moves to step 84, where the performance characteristics of the base server 12 are determined. The performance characteristics may include CPU bus memory, disk I/O, or any relevant performance characteristic of the server. Next, in step 86, the performance characteristics of the server 14 are determined. Next, in step 88, a load curve is calculated by automatically adjusting the load calculation metrics to the scale of the server 14 by comparing the performance characteristics of the server 14 to the base server 12 and appropriately scaling the load calculations accordingly. Thus, when another different server is added to the system 10, the performance of the new server is appropriately scaled to automatically determine the load calculation curve for the new server.

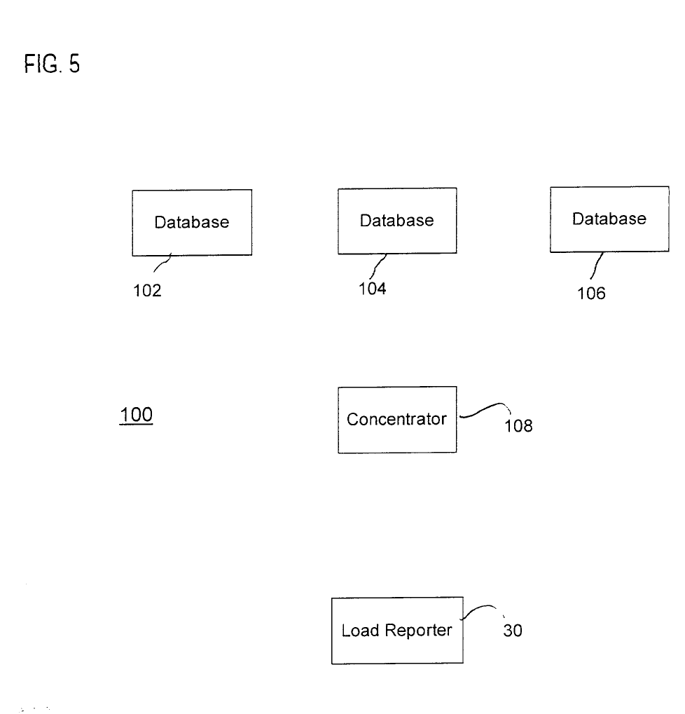

FIG. 5 is a simplified block diagram illustrating the components of a computer system 100 in an alternate embodiment of the present invention. In system 100, the load reporter 30 may monitor specific upstream or downstream resources separately (without input from a computer platform to which the downstream/upstream resource is serving), such as a plurality of databases 102, 104, and 106. The metrics for each database may be optionally compiled by a concentrator 108 and sent to the load reporter. The metrics for each database may be used separately or together to create a load curve associated with a particular service.

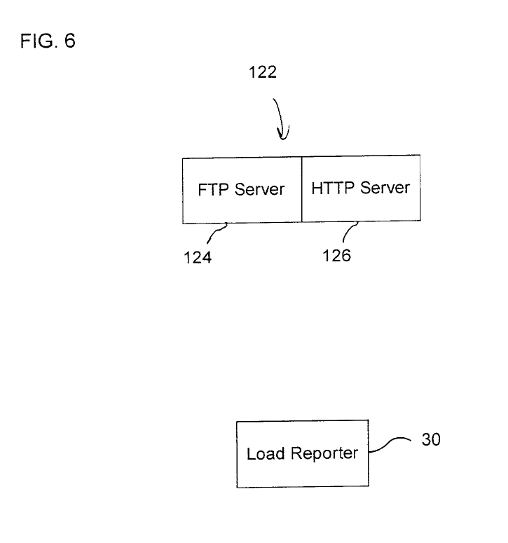

FIG. 6 is a simplified block diagram illustrating the components of a standalone computer platform 120 in an alternate embodiment of the present invention. The metrics of the standalone computer platform 122 may be monitored and reported to the load reporter 30. Specifically, the standalone computer platform does not have to be connected to a computer network. However, in alternate embodiments, the computer platform may be optionally connected to a plurality of computer platforms forming a computer network. The computing platform may include one or more load reporters monitoring separate metrics utilized in different services within the computer platform. As illustrated, one load reporter is utilized, however a plurality of load reporters may be used to create load curves for a plurality of specified services. For example, the computer platform may be both an FTP server 124 and/or an HTTP server 126. The FTP server portion may be monitored by a first load reporter, which monitors a first set of metrics associated with the FTP server portion and create a load curve based on the first set of metrics. The HTTP server portion may be monitored by a second load reporter which monitors a second set of metrics associated with the HTTP server portion and creates a load curve based on the second set of metrics.

The present invention provides many advantages over existing systems. The present invention provides a system and method for accurately determining the state or load of a service within a computer system. The load reporter accurately reports all resources used in providing a service to a client. In addition, the present invention may be automatically scaled to a wide variety of computing platforms, which provides for simple and rapid set up of new computer platforms within a computer system. The system and method also provide for the “weaning” of an operating server to be removed from service without disconnecting clients currently utilizing the server.

It is thus believed that the operation and construction of the present invention will be apparent from the foregoing description. While the method and system shown and described have been characterized as being preferred, it will be readily apparent that various changes and modifications could be made therein without departing from the spirit and scope of the invention as defined in the following claims.

What is claimed is:

1. A system for determining the state of a service for a specified computer platform, the system comprising:
a first computer platform having a plurality of load metrics defining a load on the first computer platform, said first computer platform utilized by a service;
means for obtaining the plurality of load metrics from said first computer platform; and
a load reporter for calculating from the plurality of load metrics a total load associated for the service, said load reporter providing a report of the state of the service.

2. The system of claim 1 wherein:
said first computer platform is connected to a plurality of computer platforms forming a computer network;
each computer platform of the plurality of computer platforms having a plurality of load metrics defining a load on each computer platform, said plurality of computer platforms utilized by a service within the computer network; and
further comprising means for obtaining the plurality of load metrics from each computer platform of the plurality of computer platforms, said load reporter calculating from the plurality of load metrics of each computer platform a total load associated for the service.

3. The system of claim 2 wherein one of said plurality of computer platforms is an upstream resource providing a resource to a first computer platform of said plurality of computer platforms.

4. The system of claim 2 wherein said load reporter calculates the load for the service by creating a load curve associated with the service.

5. The system of claim 4 wherein said load reporter calculates the total load for the service by calculating a first load on the first computer platform of said plurality of computer platforms and calculating a second load of an second computer platform of said plurality of computer platforms and proportionally inputting the first and second loads together to form the total load for the service, the second computer platform being an upstream resource for the first computer platform.

6. The system of claim 4 wherein said load reporter calculates the load for the service by calculating a load on at least two computer platforms of the plurality of computer platforms and proportionally inputting the load of the two computer platforms to the load curve associated with the service, the two computer platforms being utilized to provide the service.

7. The system of claim 2 wherein the load reporter provides the report to a state information consumer.

8. The system of claim 7 wherein the state information consumer is a load balancing agent.

9. The system of claim 2 wherein the load reporter provides the report to an administrator of the computer network.

10. The system of claim 2 wherein at least one of the computer platforms is a server.

11. The system of claim 10 wherein the server is an HTTP server.

12. The system of claim 2 wherein at least one of the computer platforms is a database computer platform.

13. The system of claim 2 wherein the report includes an artificially high load for a first computer platform of said plurality of computer platforms.

14. The system of claim 2 wherein the report includes a special code informing a state information consumer that no new clients should be connected to a first computer platform of said plurality of computer platforms.

15. The system of claim 1 wherein the load reporter provides the report to a traffic control application.

16. The system of claim 1 wherein said load reporter calculates the load for the service by creating a load curve associated with the service, the plurality of load metrics customizing the load curve to indicate the load for the service.

17. The system of claim 1 further comprising an upstream resource providing a resource to said first computer platform; and
wherein said load reporter calculates the total load for the service by calculating a first load on said first computer platform and calculating a second load of the upstream resource and proportionally inputting the first and second loads together to form the total load for the service.

18. The system of claim 1 further comprising:
a second computer platform having a second load metrics defining a second load on said second computer platform, said second computer platform being utilized with said first computer platform in providing the service; and
means for automatically scaling the second load on said second computer platform by determining a first set of performance characteristics of said second computer platform and comparing said second performance characters with a second set of performance characteristics of said first computer platform.

19. The system of claim 1 wherein said first computer platform includes a first computing section providing a first service and a second computing section providing a second service, said load reporter calculating from the plurality of load metrics of the first computing section the load on the first service; and
a second load reporter calculating from a second plurality of load metrics of the second computing section, a load associated with the second service.

20. A system for determining the state of a service within a computer network, the system comprising:
a first computer platform connected with the computer network, said first computer platform having a first load metrics defining a first load on said first computer platform, said first computer platform providing a service;
means for obtaining the load metrics from said first computer platform; and
a load reporter for calculating from the load metrics a total load associated for the service, said load reporter providing a report of the total load associated for the service.

21. The system of claim 20 wherein said load reporter calculates the total load associated for the service by creating a load curve indicating the total load associated with the service.

22. The system of claim 20 further comprising a second computer platform, said second computer platform being utilized with said first computer platform in providing the service.

23. The system of claim 22 wherein said load reporter calculates the total load associated for the service by calculating a second load of said second computer platform and proportionally inputting the second load into the total load associated for the service.

24. The system of claim 20 wherein the load reporter provides the report to a load balancing agent.

25. The system of claim 20 wherein the load reporter provides the report to a traffic control application.

26. The system of claim 20 wherein the load reporter provides the report to an administrator of the computer network.

27. The system of claim 20 further comprising:
a second computer platform having a second load metrics defining a second load on said second computer platform, said second computer platform being utilized with said first computer platform in providing the service; and
means for automatically scaling the second load on said second computer platform by determining a first set of performance characteristics of said second computer platform and comparing said second performance characters with a second set of performance characteristics of said first computer platform.

28. A method of determining the state of a service in a computer network, said method comprising the steps of:
determining relevant metrics defining a first load of a first computer platform, the first computer platform providing a service;
receiving the relevant metrics by a load reporter; and
calculating, by the load reporter, a total load of the service.

29. The method of claim 28 further comprising, after the step of calculating a total load of the first computer platform, the step of reporting the total load to a load balancing agent.

30. The method of claim 29 wherein the step of reporting the total load to a load balancing agent includes sending a special code informing a load balancing agent that no new clients should be connected to the first computer platform.

31. The method of claim 28 further comprising, after the step of calculating a total load of the first computer platform, the step of reporting the total load to a traffic control application.

32. The method of claim 28 further comprising, before the step of calculating a total load of the first computer platform, the step of:
determining relevant metrics defining a second load of a second computer platform;
receiving the relevant metrics of the second computer platform by a load reporter; and
wherein the step of calculating a total load includes calculating the total load of the service by calculating a second load of said second computer platform and proportionally inputting the second load with the first load of the first computer platform to determine the total load for the service.

33. The method of claim 28 wherein the load reporter calculates the total load associated for the service by creating a load curve indicating the total load associated with the service.

34. A method of determining a load of a service within a computer network, said method comprising the steps of:
determining relevant metrics defining a first load of a first computer platform, the first computer platform having a first set of performance characteristics and providing a service;
receiving the relevant metrics of the first computer platform by a load reporter;
determining relevant metrics defining a second load of a second computer platform, the second computer platform having a second set of performance characteristics;
automatically scaling the load of the second computer platform; and
calculating, by the load reporter, a total load of the service by calculating the first load and proportionally adding the second scaled load to determine the total load of the service.

35. A method of determining a state of a service within a computer network having a first computer platform and a second computer platform providing a service, said method comprising the steps of:
determining relevant metrics to define a first load on the first computer platform and a second load on the second computer platform;
retrieving the relevant metrics of the first and second computer platforms;
calculating a total load for the service by proportionally adding the first load and the second load to determine the total load.

36. The method of determining a state of a service of claim 35 further comprising, after the step of calculating a total load for the service, the step of reporting the total load to a load balancing agent.
